(19) United States
(12) Patent Application Publication
(10) Pub. No.: US 2010/0126749 A1
(43) Pub. Date: May 27, 2010

(54) Enclosure assembly

(76) Inventor: Gregory J. Dumas, Glendale, CA (US)

Correspondence Address: JAMES E. BRUNTON, ESQ., P. O. BOX 29000, GLENDALE, CA, 91209, US

(21) Appl. No.: 12/313,547

(22) Filed: Nov. 21, 2008

(51) Int. Cl. H01R 13/46

(52) U.S. Cl. 174/53

(57) ABSTRACT

An enclosure assembly that includes a molded electrical outlet box that is configured to house there within a conventional duplex outlet and a conventional prior art AC transformer that is plugged into the duplex outlet. The assembly also includes a novel cover having an opening through which the wire cable of the transformer extends. An expandable grommet which sealably engages the wire cable is mounted within the opening on the cover.

### BACKGROUND OF THE INVENTION

1. Field of the Invention

The present invention relates generally to electrical enclosures. More particularly, the invention concerns an enclosure assembly for enclosing and concealing from view a conventional transformer of the type that plugs directly into an AC power wall socket and outputs either a low DC voltage or a low AC voltage.

2. Discussion of the Prior Art

Alternating current (AC) transformers are commonly provided with a number of different types of electrically operated household devices such as cell phone re-chargers, telephone answering machines, clock radios and the like. In use, the conventional AC transformers plug directly into an AC power wall socket and output to the remotely located electrically operated device, either a low DC voltage or a low AC voltage. The output voltage is typically communicated to the electrically operated device through an elongate wire cable that is typically provided with a plug-in connector that can be plugged into the electrically operated device.

Numerous types of electrical boxes for receiving electrical components have been developed in the past. Some of these prior art boxes are metallic and others are of plastic. In either case, fasteners such as nails, screws and the like are used to secure the box to framing of the character provided for mounting dry wall or other wall paneling. A common type of receptacle is the duplex receptacle which includes a pair of spaced outlets. To affix the box cover to the duplex receptacle a fastening screw is typically passed through the center of the receptacle cover and into a threaded aperture in the front face of the receptacle between the spaced apart outlets.

Conventional prior art alternating current transformers are usually box-like and often bulky and unattractive. Additionally, when the transformer is plugged into a wall outlet it protrudes into the room, is quite unsightly, and can constitute a safety hazard. It is this problem that the present invention seeks to overcome by providing a novel enclosure assembly that conceals and safely encloses the transformer.

### SUMMARY OF THE INVENTION

It is an object of the present invention to provide an enclosure assembly comprising a molded electrical outlet box that is configured to house there within a conventional duplex outlet and a conventional prior art AC transformer that is plugged into the duplex outlet.

Another object of the invention is to provide an enclosure assembly of the aforementioned character which includes a novel cover having an opening through which the wire cable of the transformer extends.

Another object of the invention is to provide an enclosure assembly of the character described that can be installed in a conventional manner into a conventional type of framing provided for mounting dry wall or other wall paneling.

Another object of the invention is to provide an enclosure assembly of the aforementioned character that can be readily installed in both new and old construction.

Another object of the invention is to provide an enclosure assembly as described in the preceding paragraphs that is constructed of a lightweight and inexpensive material which is easy to manufacture.

Another object of the invention is to provide an enclosure assembly of the class described that is easy to use and is easy to install.

These and other objects of the invention will be achieved by the novel enclosure assembly illustrated in the drawings described in the paragraphs that follow.

### BRIEF DESCRIPTION OF THE DRAWINGS

FIG. 1 is a generally perspective view of one form of the enclosure assembly of the invention showing a conventional duplex outlet disposed within the interior space of the outlet box of one form of the invention.

FIG. 2 is a generally perspective view, similar to FIG. 1 but showing an alternating transformer plugged into the duplex outlet and disposed within the interior space of the outlet box.

FIG. 3 is a generally perspective view similar to FIG. 2 but showing the cover member of the assembly affixed to the outlet box in a manner to close the interior space thereof.

### DESCRIPTION OF THE INVENTION

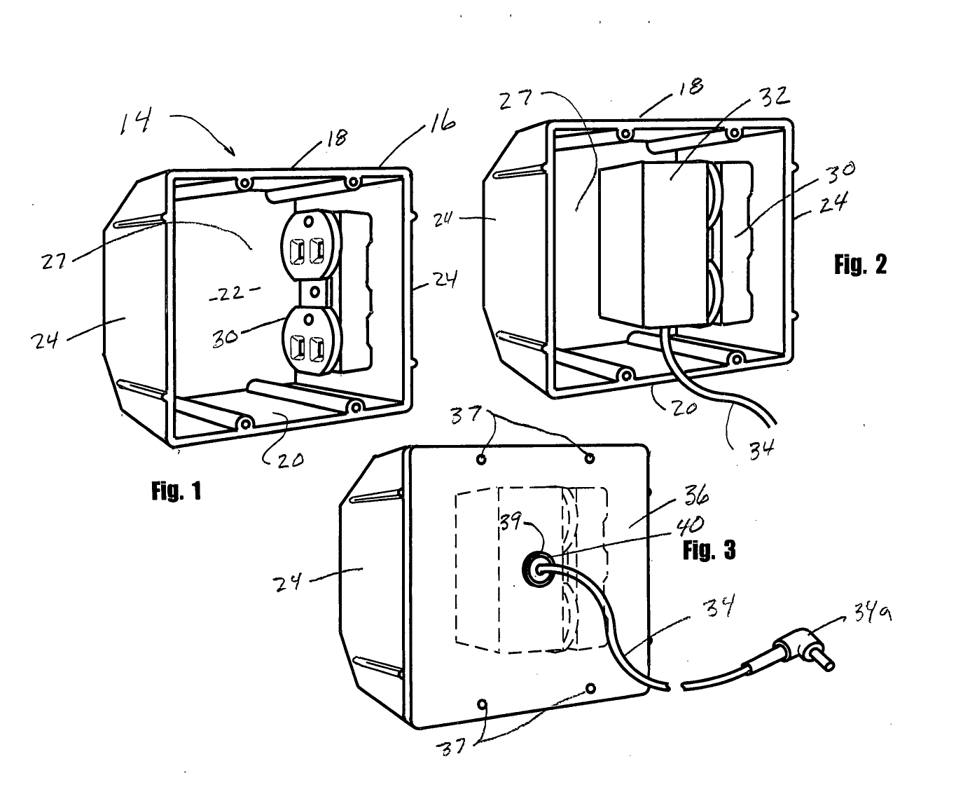

Referring to the drawings and particularly to FIG. 1, one form of the enclosure assembly of the present invention is there shown, and generally designated by the numeral 14. Enclosure assembly 14 here comprises a generally rectangular shaped outlet box 16 that can be installed in a conventional manner into a conventional type of framing provided for mounting dry wall or other wall paneling. Outlet box 16, which can be constructed from a molded plastic, from metal or from various composite materials, includes interconnected top, bottom, rear and side walls 18, 20, 22 and 24 respectively, which cooperate to define an interior space 27 having an open face.

As illustrated in FIG. 2 of the drawings, interior space 27 is sufficient to receive a duplex outlet 30 as well as an alternating current transformer 32. Duplex outlet 30 can be affixed to one side of the outlet box in any desired manner, such as by threaded screws, bolts, adhesive and the like. Alternating current transformer 32 is of character that can be plugged directly into an alternating current duplex outlet 30 in the manner illustrated and can then function to output to a remotely located electrically operated device via an elongate wire cable 34 (FIGS. 2 and 3).

As illustrated in FIG. 1 of the drawings, duplex outlet 30 is disposed within interior space 27 and is interconnected with one of said side walls 24 of outlet box 16. In the present form of the invention, the duplex outlet which can be connected to a source of alternating current, extends substantially vertically and extends generally at a right angle with respect to rear surface 22 of the outlet box or enclosure 16.

Also forming a part of the enclosure assembly of the present invention is a generally rectangular shaped cover 36 that is interconnected with enclosure 16 in the manner shown in FIG. 3 of the drawings to sealably close the open face of the enclosure 16. In the present form of the invention, cover 36 is interconnected with outlet box 16 by means of four threaded connectors 37. As illustrated in FIG. 3 of the drawings, cover 36 is provided with a generally centrally located aperture 39 within which a conventional, expandable, elastomeric grommet 40 is mounted. Grommet 40 is constructed and arranged to sealably receive there through, the elongate wire cable 34 of the alternating current transformer in the manner illustrated in FIG. 3. It is to be appreciated that grommet 40 is of a size and construction so as to permit the male connector plug 34a of the transformer 32 to be passed there through to enable its interconnection with the remotely located electrical device (not shown).

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. An enclosure assembly for enclosing there within an alternating current transformer of the character that can be plugged directly into an alternating current duplex outlet and can then function to output to a remotely located electrically operated device via an elongate wire cable a direct current voltage, said enclosure assembly comprising:
(a) an enclosure including, interconnected top, bottom, rear and side walls defining an interior space having an open face;
(b) a duplex outlet disposed within said interior space and interconnected with one of said side walls; the alternating current transformer being inter-connectable with said duplex outlet; and
(c) a cover interconnected with said enclosure for closing said open face, said cover having an aperture for receiving there through the elongate wire cable of the alternating current transformer.

2. The enclosure assembly as defined in claim 1 further including an elastomeric grommet mounted within said aperture of said cover for sealing engagement with the elongate wire cable of the alternating current transformer.

3. The enclosure assembly as defined in claim 1 in which said housing is generally rectangular in shape.

4. The enclosure assembly as defined in claim 1 in which said duplex outlet extends substantially vertically and generally at a right angle with respect to said rear surface of said enclosure.

5. An enclosure assembly for enclosing there within an alternating current transformer of the character that can be plugged directly into an alternating current duplex outlet and can then function to output to a remotely located electrically operated device via an elongate wire cable either a direct current voltage, or a low alternating current voltage said enclosure assembly comprising:
(a) a generally rectangular shaped enclosure including, interconnected top, bottom, rear and side walls defining an interior space having an open face;
(b) a duplex outlet disposed within said interior space and interconnected with one of said side walls; the alternating current transformer being inter-connectable with said duplex outlet; and
(c) a generally rectangular shaped cover interconnected with said enclosure for closing said open face, said cover having:
(i) a generally centrally located aperture; and
(ii) an expandable grommet for sealably receiving there through the elongate wire cable of the alternating current transformer.

6. The enclosure assembly as defined in claim 5 in which said duplex outlet extends substantially vertically and generally at a right angle with respect to said rear surface of said enclosure.

7. The enclosure assembly, as defined in claim 5, in which said generally rectangular shaped enclosure and said generally rectangular shaped cover are constructed from a moldable plastic.

8. The enclosure assembly as defined in claim 5 in which said generally rectangular shaped enclosure and said generally rectangular shaped cover are constructed from a metal.
